(19) United States
(12) Patent Application Publication
(10) Pub. No.: US 2006/0080886 A1
(43) Pub. Date: Apr. 20, 2006

(54) Reconfigurable fishing lure

(76) Inventor: Matthew C. Gawlik, Glen Ellyn, IL (US)

Correspondence Address: Jerry A. Schulman, Terrace Executive Center, Court C, One South 376 Summit Avenue, Oakbrook Terrace, IL, 60181, US

(21) Appl. No.: 10/966,331

(22) Filed: Oct. 16, 2004

(51) Int. Cl. A01K 85/00

(52) U.S. Cl. 43/42.19; 43/42.09

(57) ABSTRACT

A reconfigurable fishing lure has a relatively thick solid metal wire body onto which are mounted various lure components such as weights, spinner brackets, spacer beads and the like. A pair of holes are drilled though the body proximate each end and removable fasteners are secured in each hole to hold the lure components on the wire body and to allow the components to be removed and changed. The wire body and fasteners are sufficiently sturdy to withstand the force of a hooked fish.

### BACKGROUND OF THE INVENTION

This invention relates to fishing lures, and more particularly, to a bucktail lure having a solid wire body onto which are mounted blades, weights, hook clusters and other lure accessories. In a preferred embodiment of the invention, the wire body is formed from a straight relatively thick metal wire having a hole drilled at each end. The wire body accepts lure accessories having holes formed therethrough to closely match the exterior diameter of the wire body. Split ring fasteners are inserted through the wire body holes to retain the lure accessories on the body when the lure is in use. Removal of one or both split ring fasteners allows the user to change accessories as needed or desired. This allows the lure to be modified while fishing instead of keeping a stock of already-assembled lures with different lure components.

It is not uncommon for a fisherman to have a number of lures to be used under different fishing conditions such as clarity, depth and temperature of water, weather, and the depth at which are found to be feeding. The present invention allows the configuration of the lure to be changed by adding or replacing various lure components and thus reduces the need to purchase a number of pre-assembled lures. Substitution of lure components is a more flexible and economical approach allowing a fisherman to construct an appropriate lure while fishing.

### DESCRIPTION OF THE PRIOR ART

As is to be expected, a large and well-developed body of prior art exists with respect to fishing lures.

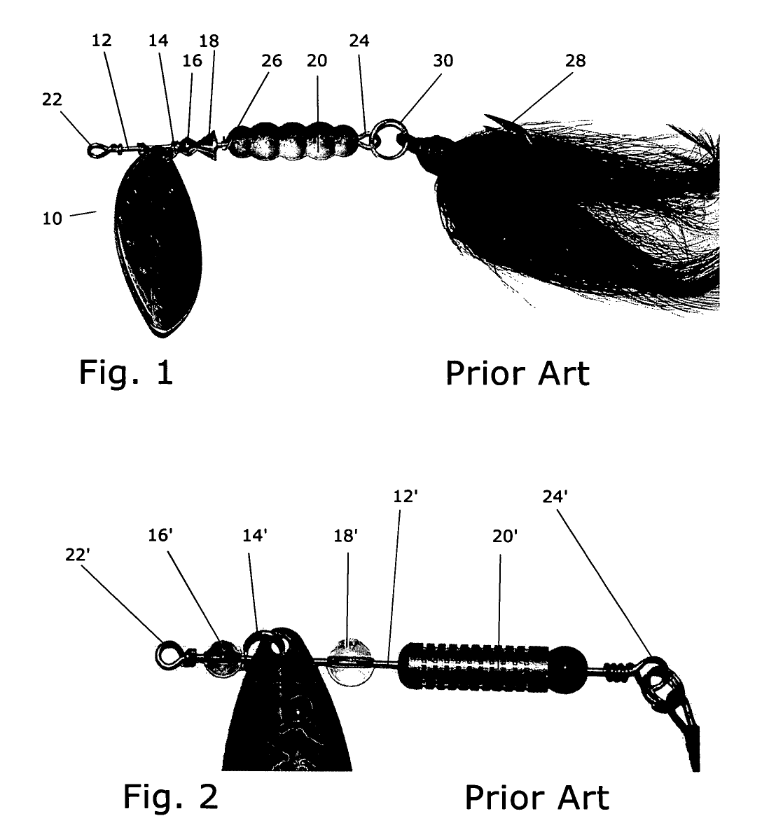

A common lure construction is illustrated in FIG. 1 herein, known generally as a “bucktail” lure, is sold under the Mepps® trademark by Sheldon's, Inc. of Antigo, Wis. under the model name “Giant Killer®”. This lure consists of a wire body onto which lure components such as weights, blades and beads are mounted. These components are held on the wire body by forming the ends of the wire into loops which are larger in diameter than the holes on each component through which the wire is passed. As shown in FIG. 1, such loops are formed at both ends of the body. If it becomes desirable or necessary to remove a lure component, the wire must be twisted to undo one of the loops and must be straightened sufficiently to allow the selected component to slide off the wire body. Repeated untwisting and retwisting will eventually weaken the wire body to the point where the wire may snap. If this occurs while casting or attempting to reel in a fish, the entire lure and lure components (and the fish) may be lost.

U.S. Patent Application Publication 2002/0148155 (Pasley) teaches and describes quick disconnect spinner blades which are attachable and removable from a lure body through use of various spring biased connectors similar to those used as clasps for jewelry. The lure shown in Pasley has a solid wire body with twisted ends such as that shown in FIG. 1 and the spinner blades are attachable either to the loop formed at the end of the wire body or to a U-shaped rotator mounted to the body prior to twisting the end to form the closure loop. Pasley mentions use of spring biased connectors as preferable to using the split ring connectors. However, the quick-release connectors used by Pasley are only required to hold the blade to the lure body, not to withstand the force of a hooked fish.

U.S. Pat. No. 6,601,336 (Link) teaches and describes a filamentary spinner blade and rattle dressing selectably attachable to special collars or fittings that are attached to a lure. Link uses flexible elastomeric collars and lines to attach fish-attracting components of the lure but which are not and cannot be used to secure the hook cluster or any other strain-bearing components.

U.S. Pat. No. 4,891,901 (Baker Jr.) teaches and describes fishing lures having novel spinner blades. Baker Jr. describes a number of lure configurations and a number of lure components generally held together with split ring fasteners. Those lures having wire bodies are shown as having twisted loops formed at the end of the wire bodies to which the components described by Baker Jr. are attached.

U.S. Pat. No. 4,202,127 (Merek) teaches and describes a noise making lure having split ring fasteners used to attach the lure body parts together and to attach a hook assembly to the lure body parts. Merek does not however, teach or suggest the capacity to substitute lure components on the lure body.

U.S. Pat. No. 2,307,310 (Bryan) teaches and describes a fish lure having body parts held together with split ring fasteners. Although the lure is so assembled, Bryan neither teaches nor suggests a substitution of lure components on a straight wire body.

U.S. Pat. No. 3,905,147 (Snipes) teaches and describes a fishing lure with a central, hollow cavity through which water passes when the lure is cast, creating a sound audible to fish. Although Snipes discloses the use of split ring fasteners to attach hook clusters and fishing line to the lure body, there is no teaching of the use of such fasteners to allow lure components to be added to the lure body itself.

U.S. Pat. No. 5,628,139 (Rhoten) teaches and describes an attachment for a fishing lure consisting of a trailing spinner and also teaches a bent wire retainer used as an attachment device. The attachment portion of the lure serves an attracting purpose only and does not absorb the force exerted by a hooked fish.

U.S. Pat. No. 2,909,863 (Rector) describes the use of rings to attach the line ring and the hook cluster to the lure. Rector does not describe the rings as split nor does it describe the adjustability of the lure by the removal of the rings, addition of components to the lure body and the reinstallation of the rings.

U.S. Patent Application Publication 2003/014435 (Carver) teaches and describes a quick release detachable buckle having a solid shaft with holes formed at either end, a wire clip passed through one of the holes and a retainer pin through the other hole to hold the shaft to the body of a buckle. The design in Carver does not require the shaft to withstand axial strain or force but instead the shaft is positioned to accept such force transverse to the axis of the shaft so that the purpose of the wire retainer and the straight pin retainer is to keep the shaft attached to the buckle but not to accept any force or strain thereon.

It is an object of the present invention to provide fishing lures having straight wire bodies to which various lure components can be removably secured.

It is a further object to provide such lures with sturdy yet easily removable retainers attachable to each end of the shaft to keep the selected lure components in place.

It is another object to provide such lures with the capability of accepting a variety of lure components to obviate the need for purchasing a large number of specifically configured lures.

It is another object of the present invention to provide lures where the mechanism for changing the lure components also has the capacity to absorb the force exerted by a hooked fish.

It is another object of the present invention to provide such lures in forms which are simple to manufacture, sturdy in construction and economical to assemble.

### SUMMARY OF THE INVENTION

These and other objects of the present invention are embodied in a novel, adjustable lure characterized by a unitary solid cylindrical wire body, a selected series of lure components including swivels, weights, beads and the like through which mounting channels are formed closely corresponding to the outer diameter of the wire body and a number of split ring or similar fasteners used to close off the wire body and retain the selected components thereon by inserting the fasteners through the wire body retaining holes.

These and other characteristics of the present invention will be best understood by reference to the accompanying drawings in which:

FIG. 1 is a perspective view of a first prior art “bucktail” fishing lure having a solid wire body closed off by twisted loops;

FIG. 2 is an enlarged detail of a second prior art “bucktail” lure;

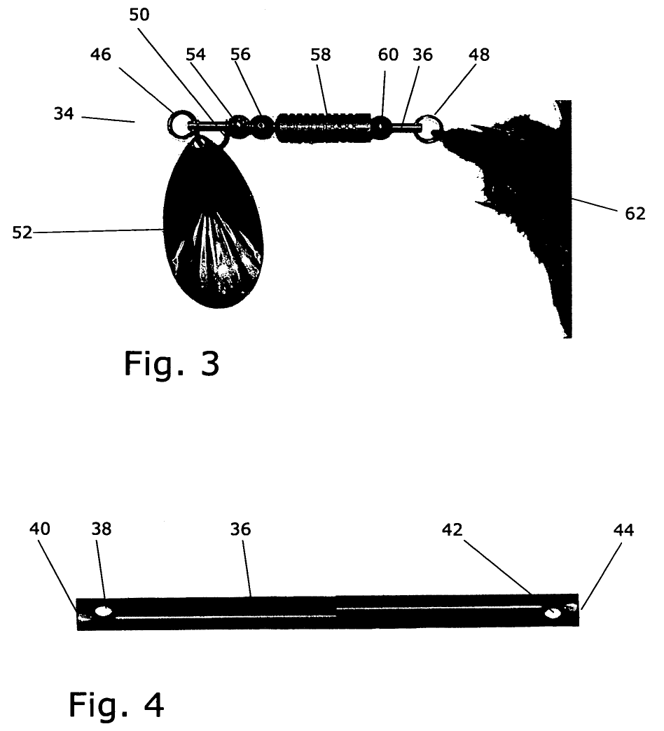

FIG. 3 is a perspective view of a bucktail lure assembled in accordance with the teachings of a preferred embodiment of the preferred invention;

FIG. 4 is an enlarged detail of the wire body of FIG. 3;

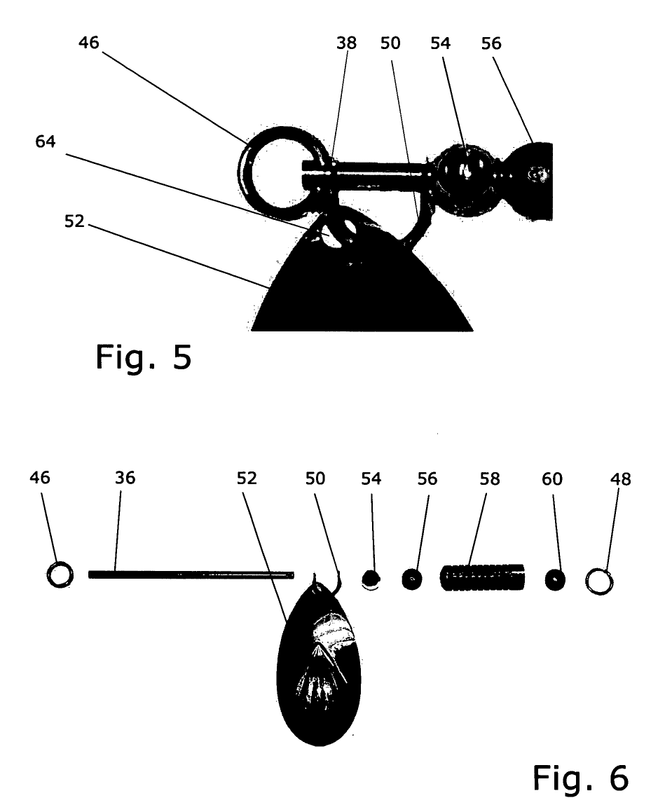

FIG. 5 is an enlarged detail of a portion of the lure shown in FIG. 3; and

FIG. 6 is an exploded view of the lure components shown in FIG. 3.

### DETAILED DESCRIPTION OF THE INVENTION

Referring now to FIG. 1, the numeral 10 indicates generally a prior art bucktail fishing lure as made and sold under the trademarks Mepps® and Giant Killer®. Lure 10 has a solid wire body 12 onto which are mounted a blade and swivel bracket 14, a first solid spacer bead 16, a second spacer bead 18 and a weight 20. Beads 16, 18 are conventionally formed from plastic or metals such as brass and each has a mounting hole sized to allow wire body 12 to be inserted therethrough. In like fashion, weight 20 is conventionally formed from metal or plastic and has a similar hole formed therethrough while swivel bracket 16 is generally U-shaped and has a pair of holes bored proximate the ends of the legs of the U-shaped swivel.

As seen in FIG. 1, wire body 12 is closed off by a first loop 22 and a second loop 24. Loop 22 is formed by bending back a portion of one end of wire body 12 and then twisting that portion to form generally circular closed loop 22. Loop 24, in this embodiment, is formed by bending back a portion of body 12 to form the loop and then inserting weight 20 over both wire portions. A bend 26 is formed in that portion of body 12 that protrudes past the end of weight 20 distal from loop 24 to keep weight 20 in place. Loops 22, 24 are large enough in diameter to retain components such as bracket 14, beads 16, 18, and weight 20 on wire body 12.

As shown in FIG. 1, a hook cluster 28 is attached to loop 24 through use of a split ring fastener 30. When a lure such as that shown in FIG. 1 is used, a fishing line is attached to loop 22 and the strain experienced when a fish is hooked is absorbed by loop 22, wire body 12, loop 24, split ring 30 and hook cluster 28.

Referring now to FIG. 2, an enlarged view of a portion of a second prior art lure 10′ having a blade and bracket 14′, beads 16′, 18′ and weight 20′ formed on body 12′. In this embodiment, loop 22′ is formed by twisting an end of body 12′, as described above. However, loop 24′ is also formed by twisting the opposite end of body 12′ rather than passing a portion of body 12′ through weight 20′.

Referring now to FIG. 3, the numeral 34 indicates generally a lure assembled in accordance with the teachings of a preferred embodiment of the present invention. Lure 34 has a solid wire body 36 which is relatively thicker in diameter than is the lure body 12 of lure 10. Generally, a lure body such as lure 12 is formed from a metallic wire with a 0.062 inch diameter while lure body 36 is thicker, formed preferably with a larger diameter of about 0.093 inch.

As seen in FIG. 4, lure body 36 has a first mounting hole 38 drilled or otherwise formed therethrough proximate end 40 and a second mounting hole 42 drilled or otherwise formed therethrough proximate end 44. As seen in FIG. 3 and in greater detail in FIG. 5 a first split ring fastener 46 is passed through hole 38. As seen in FIG. 3, a second split ring fastener 48 is passed through hole 42.

As typified by the lure arrangement in FIG. 3, lure 34 has a spinner mounting bracket 50 rotatably mounted thereto to which a blade 52 is attached, a first spacer bead 54, a second spacer bead 56 a weight 58 and a third spacer bead 60. Each of the beads 54, 56 and 60 have centrally formed apertures as described hereinabove and with the larger diameter of wire body 36 these apertures must be made larger than standard spacer beads. In like fashion, bracket 50 and weight 58 have larger mounting apertures than are conventionally known. A hook cluster 62 is attached to split ring 48 and thereby to lure 34.

As best seen in FIG. 5, blade 52 is mounted to bracket 50 by passing bracket 50 through a blade aperture 64 prior to assembling bracket 50 to body 36.

Referring now to FIG. 6, a disassembled view of lure 34 is shown with body 36 having split ring 48 removed therefrom allowing the removal of bracket 50 and, thereby, blade 52, beads 54, 56 and 60, and weight 58. It is now apparent that the configuration of lure 34 may be changed simply by removing split ring 46 and substituting different blades, spinners, beads, weights, or other lure components as desired.

Thus, it is possible for a fisherman to make changes to the lure to adapt to conditions. For example, for deeper water, heavier weights may be added, for different water conditions or different species of fish, different blades or other attractive elements may be selected and different fish hook clusters and cluster adornments may also be selected. These components can be easily changed during a day of fishing without requiring the fisherman to stock a wide variety of lures on which these various components are already mounted or to untwist the ends of a conventional wire-body lure to change components. Instead, the fisherman need only carry a selection of individual components which may be added to or removed from the lure body as desired.

In use, the fishing line is attached to ring 46 or another component which is attached to ring 46 which means that the force absorbed when a fish strikes and is hooked, is taken up by a fishing line (not shown) split ring 46, wire body 36, split ring 48, and hook cluster 62. This results in a simple, sturdy and serviceable construction adaptable for a wide variety of fish and fishing conditions.

Other fasteners can be used to close off the ends of wire body 36. For example, a portion of each end of wire body 36 can be threaded to accept a nut or other similarly threaded fitting.

While the foregoing describes a preferred embodiment or embodiments of the present invention, it is to be understood that such description is made by way of example only and is not intended to limit the scope of the present invention. It is expected that alterations and further modifications, as well as other and further applications of the principles of the present invention will occur to others skilled in the art to which the invention relates and, while differing from the foregoing, remain within the spirit and scope of the invention as herein described and claimed. Where means-plus-function clauses are used in the claims such language is intended to cover the structures described herein as performing the recited functions and not only structural equivalents but equivalent structures as well. For the purposes of the present disclosure, two structures that perform the same function within an environment described above may be equivalent structures.

1. A fishing lure, said lure comprising:
a solid, cylindrical body having first and second ends;
a first mounting aperture formed through said body proximate said first end;
a second mounting aperture formed through said body proximate said second end;
at least one lure component,
each said lure component having a mounting channel formed therethrough,
said mounting channel sized and shaped to allow said body to be passed through said lure component;
first means for retaining said lure component on said body,
said first retaining means comprising means for removably engaging said first mounting aperture; and
second means for retaining said lure component on said body,
said second retaining means comprising means for removably engaging said second mounting aperture.

2. The apparatus as recited in claim 1 wherein said lure body is a solid cylindrical wire.

3. The apparatus as recited in claim 2 said lure component is a lure weight.

4. The apparatus as recited in claim 2 said lure component is a spinner blade.

5. The apparatus as recited in claim 2 said lure component is a fish hook.

6. The apparatus as recited in claim 2 said lure component is a rattle.

7. The apparatus as recited in claim 2 said wire body is about 0.093 inch in diameter.

8. A fishing lure, said lure comprising:
a solid, cylindrical body having first and second ends;
at least one lure component,
each said lure component having a mounting channel formed therethrough,
said mounting channel sized and shaped to allow said body to be passed through said lure component;
means for retaining said lure component on said body,
said retaining means comprising a first mounting aperture formed through said body proximate said first end,
first means for engaging said first mounting aperture,
said retaining means further comprising a retaining element attached to said body proximate said second end,
said first engaging means and said retaining element being larger than the diameter of said mounting channel,
said first engaging means being removably engaged with said mounting aperture.

9. The apparatus as recited in claim 8 wherein said lure body is a solid cylindrical wire.

10. The apparatus as recited in claim 9 said lure component is a lure weight.

11. The apparatus as recited in claim 9 said lure component is a spinner blade.

12. The apparatus as recited in claim 9 said lure component is a fish hook.

13. The apparatus as recited in claim 9 said lure component is a rattle.

14. The apparatus as recited in claim 9 said wire body is about 0.093 inch in diameter.
